(19) United States
(12) Patent Application Publication
(10) Pub. No.: US 2006/0182307 A1
(43) Pub. Date: Aug. 17, 2006

(54) Speaker diaphragm, speaker unit and speaker apparatus

(75) Inventor: Takao Sakamoto, Saitama (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/342,709

(22) Filed: Jan. 31, 2006

(30) Foreign Application Priority Data
Feb. 9, 2005 (JP) 2005-033242

(51) Int. Cl. H04R 11/02

(52) U.S. Cl. 381/423; 381/424

(57) ABSTRACT

To keep sounds emitted from a speaker apparatus in high quality. According to one embodiment of the present invention, a top layer and a back layer in a diaphragm of a speaker unit built in a speaker apparatus, and a reinforcement board for reinforcement which is interposed between the top layer and the back layer, and is disposed from the center part of diaphragm to the outer circumference part of diaphragm of the speaker diaphragm are provided. Thereby, unnecessary vibration caused by lack of the rigidity of the diaphragm can be prevented, and a possibility that the reinforcement board comes off or falls off can be remarkably reduced.

### CROSS REFERENCE TO RELATED APPLICATIONS

The present invention contains subject matter related to Japanese Patent Application JP 2005-033242 filed in the Japanese Patent Office on Feb. 9, 2005, the entire contents of which being incorporated herein by reference.

### BACKGROUND OF THE INVENTION

1. Field of the Invention

The present invention relates to a speaker diaphragm, a speaker unit and a speaker apparatus, and is suitably applied, for example, to a conic speaker diaphragm.

2. Description of the Related Art

In a speaker apparatus in that a speaker unit having a conic speaker diaphragm is built in, the speaker diaphragm is vibrated in accordance with an input signal supplied from an amplifier or the like, and the state of thin/thick of the air is changed, so that a sound corresponding to the input signal is produced and emitted.

For example, in a speaker unit built in a speaker apparatus in general, magnetic force is generated by a voice coil in accordance with an input signal being alternating current wave, and a speaker diaphragm formed in one body with the voice coil is vibrated in accordance with the magnetic force, so that a sound corresponding to the input signal is produced.

By the way, in the speaker apparatus having such configuration, a sound faithfully according to the input signal, that is, high quality sound can be emitted by that the speaker diaphragm in the speaker unit is accurately vibrated in accordance with the input signal. Therefore, it is desired that the speaker diaphragm vibrate as fast as possible and also it does not transform, that is, reducing the weight and high rigidity are required.

Furthermore, speaker units are different in a frequency band that can emit a high quality sound, depending on its configuration and the caliber of a speaker diaphragm or the like. Therefore, in a speaker apparatus, plural different kinds of speaker units are combined and built in, or plural kinds of such speaker apparatuses in that different speaker units are built in are combined and used, so that emitted sound quality can be improved.

In speaker units, especially in a sub woofer for outputting a low frequency band (for example, 5 Hz-400 Hz), the caliber of the speaker diaphragm is comparatively large (for example, 300 mm). Therefore, there has been a possibility that the weight of the speaker diaphragm is heavy and the speaker diaphragm lacks in rigidity.

Therefore, in some of speaker units, there has been proposed that for example, a speaker diaphragm is reinforced by adhering a metal plate to the speaker diaphragm to improve rigidity [for example, refer to Jpn. Pat. Appln. Laid-Open Publication No. 2002- 135888 (FIG. 2, page 4)].

### SUMMARY OF THE INVENTION

However, in a speaker apparatus having such configuration, since a speaker diaphragm in a speaker unit always vibrates during emission of sound, there has been a possibility that a metal plate adhered to the diaphragm comes off or falls off, by causes such that adhering processing in incomplete or that adhesion power lowers by aging.

In such case, in the speaker apparatus, rigidity of the speaker diaphragm in the speaker unit lowers, and unnecessary vibration is generated. Therefore, there has been a problem that the quality of emitted sound is remarkably deteriorated.

The present invention has been done considering the above points, and is proposing a speaker diaphragm, a speaker unit and a speaker apparatus in that the quality of sound emitted from a speaker apparatus can be kept.

To obviate such problems, according to a speaker diaphragm of the present invention, it is a speaker diaphragm built in a speaker apparatus, and a vibrating surface forming the speaker diaphragm, and a thin plate-like member for reinforcement, interposed between the front surface and the back surface of the vibrating surface, and disposed from the center side to the outer circumference side of the speaker diaphragm are provided.

Therefore, the thin plate-like member does not come off or fall off from the vibrating surface. Thus, unnecessary vibration caused by lack of rigidity when the speaker diaphragm is vibrated can be prevented, and the sound quality of emitted sound can be kept.

Further, according to a speaker unit of the present invention, it is a speaker unit having a speaker diaphragm, and the speaker diaphragm includes a vibrating surface forming the speaker diaphragm, and a thin plate-like member for reinforcement, interposed between the front surface and the back surface of the vibrating surface, and disposed from the center side to the outer circumference side of the speaker diaphragm.

Therefore, the thin plate-like member does not come off or fall off from the vibrating surface. Thus, unnecessary vibration caused by lack of rigidity when the speaker diaphragm is vibrated can be prevented, and the sound quality of emitted sound can be kept.

Further, according to a speaker apparatus of the present invention, it is a speaker apparatus with a speaker unit having a speaker diaphragm fixed in a predetermined speaker box, and the speaker diaphragm includes a vibrating surface forming the speaker diaphragm, and a thin plate-like member for reinforcement, interposed between the front surface and the back surface of the vibrating surface, and disposed from the center side to the outer circumference side of the speaker diaphragm.

Therefore, the thin plate-like member does not come off or fall off from the vibrating surface. Thus, unnecessary vibration caused by lack of rigidity when the speaker diaphragm is vibrated can be prevented, and the sound quality of emitted sound can be kept.

According to one embodiment of the present invention, a thin plate-like member does not come off or fall off from the vibrating surface. Therefore, a speaker diaphragm, a speaker unit and a speaker apparatus in that unnecessary vibration caused by lack of rigidity when the speaker diaphragm is vibrated can be prevented, and the sound quality of emitted sound can be kept can be realized.

The nature, principle and utility of the invention will become more apparent from the following detailed description when read in conjunction with the accompanying drawings in which like parts are designate by like reference numerals or characters.

### BRIEF DESCRIPTION OF DRAWINGS

In the accompanying drawings:

FIG. 1 is a schematic perspective view showing the configuration of a speaker apparatus according to one embodiment of the present invention;

FIG. 2 is a schematic front view showing the configuration of a speaker unit according to one embodiment of the present invention;

FIG. 3 is a schematic sectional view showing the cross section by A1-A2 in the speaker unit of FIG. 2;

FIG. 4A is a schematic front view showing the configuration of a diaphragm;

FIG. 4B is a schematic sectional view showing the cross section by B1-B2;

FIG. 5 is a schematic front view showing the configuration of a reinforcement board;

FIG. 6 is a schematic front view showing the configuration of a conventional speaker unit;

FIG. 7 is a schematic diagram showing the simulation result of vibration in a conventional diaphragm;

FIG. 8 is a schematic diagram showing the simulation result of vibration in a diaphragm according to one embodiment of the present invention;

FIG. 9 is a schematic diagram showing the input/output characteristic of a speaker unit;

FIG. 10 is a schematic front view showing the configuration of a reinforcement board according to other embodiment (1);

FIG. 11 is a schematic front view showing the configuration of a reinforcement board according to other embodiment (2); and

FIG. 12 is a schematic front view showing the configuration of a reinforcement board according to other embodiment (3).

### DETAILED DESCRIPTION OF THE PREFERRED EMBODIMENTS

An embodiment of the present invention will be described in detail with reference to the accompanying drawings.

(1) Configuration of Speaker Apparatus

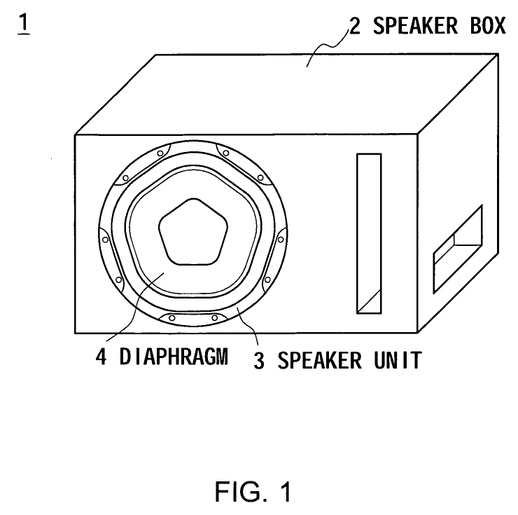

Referring to FIG. 1, the reference numeral 1 shows the general configuration of a speaker apparatus according to one embodiment of the present invention as a whole. A speaker unit 3 is fixed to a speaker box 2 that wooden boards in a predetermined shape are made in a box shape.

In the speaker apparatus 1, a so-called conic diaphragm 4 built in the speaker unit 3 is vibrated in accordance with an input signal supplied from an external amplifier (not shown) or the like. Thereby, the thin/thick state of the air is changed, and a sound corresponding to the input signal can be produced.

In this connection, the speaker apparatus 1 is defined as for automobile, and it is supposed to be installed in the trunk or the like of an automobile. Further, the speaker unit 3 is a sub woofer for reproducing a low frequency band (for example, 5 Hz - 400 Hz), and the caliber of the diaphragm 4 (that is, the diameter in the outer circumference part when in viewing from the front) is designed to be approximately 300 mm.

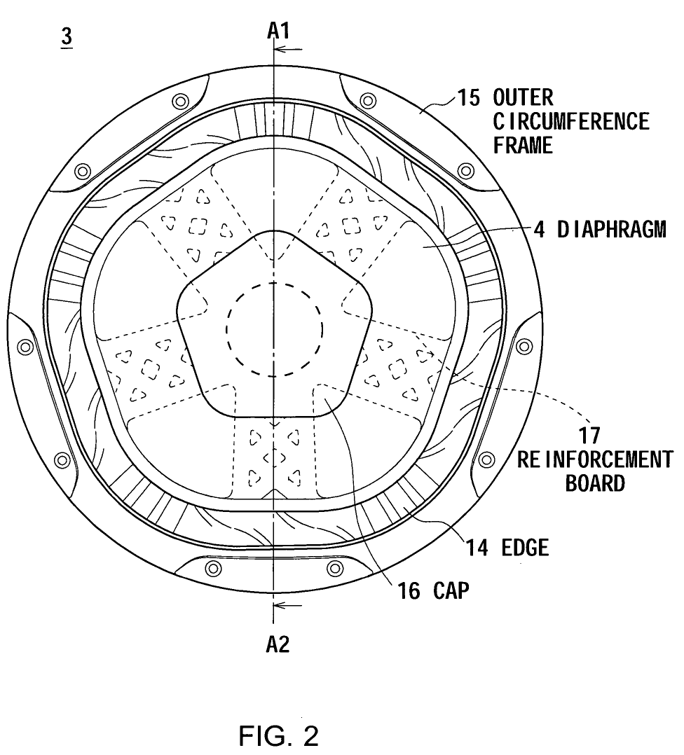

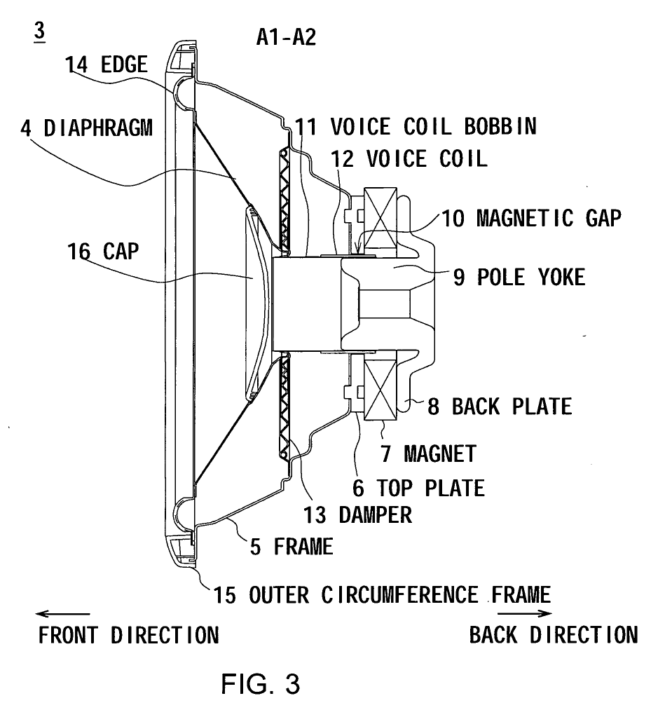

In the speaker unit 3, as shown in FIGS. 2 and 3, a top plate 6 in an almost disc shape is fixed to the back side of a frame 5 in an almost mortar shape that a metal board of a predetermined thickness was subjected to press working. Further, a magnet 7 in an almost disc shape is attached to the back side.

A back plate 8 in an almost disc shape is attached to the back side of the magnet 7, and a pole yoke 9 is provided so as to protrude from the center part of the above back plate 8 in the front direction. The pole yoke 9 penetrates the magnet 7, and a magnetic gap 10 is formed between the magnet 7 and the top plate 6, so that a magnetic circuit is formed.

A voice coil bobbin 11 is made of an almost cylindrical metallic material, and a voice coil 12 is coiled up so as to be positioned in the magnetic gap 10. The voice coil 12 is connected to a connecting terminal attached to the frame 5 (not shown) via a lead wire (not shown), and an input signal being alternative wave inputted from an external amplifier or the like (not shown) is supplied.

Furthermore, the voice coil bobbin 11 is supported by a damper 13, and also is attached to the back center part of the diaphragm 4. Thereby, the voice coil bobbin 11 can be moved (vibrated) in the forward and backward directions in one body with the diaphragm 4.

The diaphragm 4 has a cap 16 made from hard resin material, attached to the front center part, and also is attached to the frame 5 and an outer circumference frame 15 via an edge 14 made from resin raw material having bendability in the front outer circumference part. Thereby, the diaphragm 4 can be freely moved (vibrated) in the forward and backward directions to the frame 5.

That is, in the speaker unit 3, electromagnetic force is generated in the voice coil 12 in accordance with an input signal from the outside. By the above electromagnetic force, the diaphragm 4, the cap 16, the voice coil bobbin 11 and the voice coil 12 are vibrated in one body in the forward and backward directions to other parts such as the frame 5. At this time, the speaker unit 3 can produce a sound corresponding to the input signal by vibrating the surrounding air.

In this connection, the speaker unit 3 can cope with input signals to 1600 W as instantaneous maximum input power, by the limitation of the voice coil 12.

By the way, in general, in a speaker diaphragm, when the speaker diaphragm vibrates at high speed and at high amplitude by the reason that the power of an input signal is extremely large or the like, the speaker diaphragm cannot be vibrated in one body by lack of rigidity, and a part of it is vibrated in a different phase, so-called split vibration sometimes causes.

In a conic speaker diaphragm widely used in general, when the split vibration is generated, inverted vibration which has an inverted phase to the proper vibration arises at even number of parts. Therefore, the parts of inverted vibration generated at the positions facing with the center of the cone between resonances with each other; it remarkably deteriorates the quality of emitted sound.

From that reason, as shown in FIGS. 2 and 3, the diaphragm 4 is formed in an almost pentagonal cone shape, that is, in a shape formed by only the side parts of an almost pentagonal cone base of which the corner parts are gentle ascent (hereinafter, this is referred to as an almost pentagonal cone shape). Thereby, the part of inverted vibration when the split vibration generated is made to be five parts (that is, odd number of parts), and the parts of inverted vibration does not face to each other. Thus, resonance can be prevented.

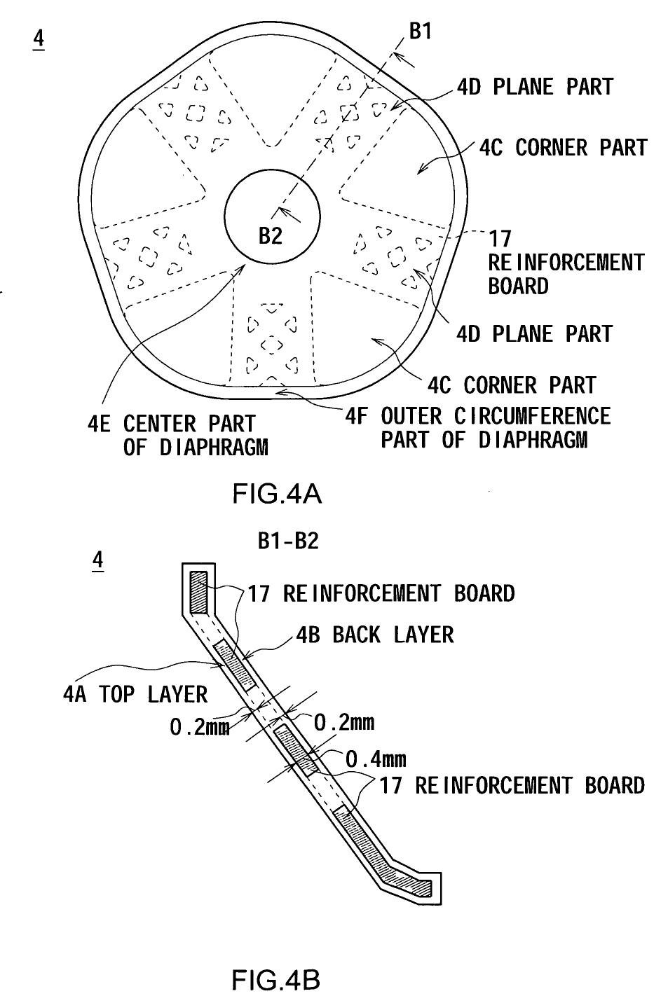

Furthermore, as shown in FIGS. 4A and 4B, the diaphragm 4 has the configuration with the reinforcement board 17 between the top layer 4A and the back layer 4B (hereinafter, being positioned with something between two as the above is referred to as “being interposed”).

Practically, when it is manufactured, the diaphragm 4 is molded in one body with the reinforcement board 17 by so-called insert molding. The way is that a predetermined mold is filled with polypropylene resin in the state where the reinforcement board 17 that a plate-like aluminum was previously formed in a predetermined shape by press working has been set in the mold.

That is, as shown in FIG. 4B as a sectional view, in the diaphragm 4, the reinforcement board 17 is interposed between the top layer 4A and the back layer 4B and is totally buried. Therefore, coming off, falling off or the like of the reinforcement board 17 from the diaphragm 4 can be prevented.

In this connection, in the diaphragm 4, the thickness of a corner part 4C in that the reinforcement board 17 is not interposed is approximately 0.8 mm. On the contrary, the thickness of the reinforcement board 17 is 0.4 mm, and the thickness of the top layer 4A and the back layer 4B is both approximately 0.2 mm. Thus, also the thickness of the diaphragm 4 in the plane part 4D is set to approximately 0.8 mm.

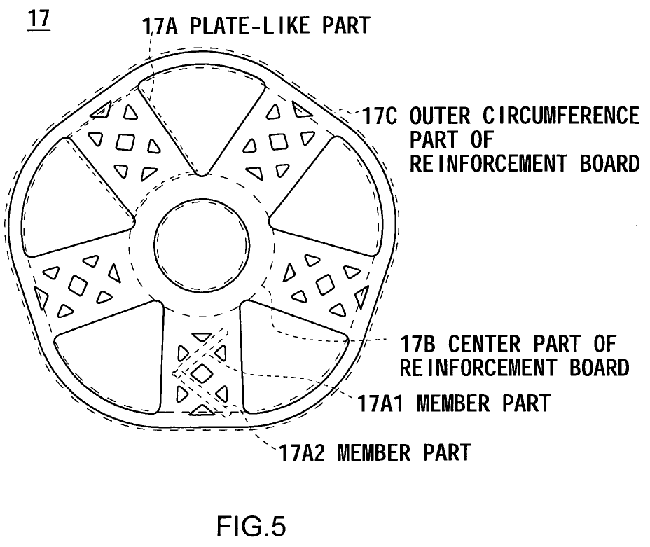

Here, the configuration of the reinforcement board 17 is shown in FIG. 5. The reinforcement board 17 is made of an almost pentagonal aluminum plate subjected to press working. If roughly classifying, the reinforcement board 17 is composed of five plate-like parts 17A, an almost circumferential center part of reinforcement board 17B that is connected with each plate-like part 17A on the center side of the pentagon (that is, on the inner circumference side), and a circumferential outer circumference part of reinforcement board 17C that is connected with each plate-like part 17A on the outer circumference side.

The plate-like part 17A is in a rectangular thin plate shape, and is disposed so as to reinforce the plane part 4D from the center part of diaphragm 4E to the parts of sides of the almost pentagon of the outer circumference part of diaphragm 4F in the diaphragm 4 (FIG. 4A). Furthermore, the center side and the outer circumference side are connected with the center part of reinforcement board 17B and the outer circumference part of reinforcement board 17C respectively, and they are formed in one body.

Thereby, in the diaphragm 4 (FIGS. 4A and 4B), the rigidity between the center part of diaphragm 4E, the outer circumference part of diaphragm 4F and the plane part 4D is reinforced. Thus, a possibility that the plane part 4D, the center part of diaphragm 4E and the outer circumference part of diaphragm 4F are vibrated in a mutually different phase (that is, do split vibration) is remarkably reduced.

On the other hand, in the reinforcement board 17, a fan-shaped part corresponding to the corner part 4C of the diaphragm 4 is bored large. Thus, the corner part 4C is not reinforced.

Thereby, in the diaphragm 4, the plane part 4D which had a possibility of relative rigidity lacking as compared to the corner part 4C is reinforced. Thus, rigidity in the corner part 4C and the plane part 4D can be set to be almost equal.

Further, in the reinforcement board 17, plural holes are provided on the plate-like part 17A, and also the parts other than the plural holes form truss structure as a member part 17A1, a member part 17A2 or the like. Thereby, the weight of reinforcement board 17 can be reduced while keeping rigidity in the plate-like part 17A.

(2) Operation and Effect

According to the above configuration, in the diaphragm 4, the reinforcement board 17 is interposed between the top layer 4A and the back layer 4B, so that the rigidity of the diaphragm 4 itself can be improved.

At this time, in the diaphragm 4, the plane part 4D is reinforced by the plate-like part 17A of the reinforcement board 17, and the rigidity of the plane part 4D is improved to the same degree as the corner part 4C. Therefore, the rigidity of each part in the diaphragm 4 can be set to be almost equal.

Furthermore, in the diaphragm 4, in the reinforcement board 17 (FIG. 5), each plate-like part 17A, the center part of reinforcement board 17B and the outer circumference part of reinforcement board 17C are formed in one body. Thereby, at the time of vibration, split vibration is generated at the plane part 4D of the diaphragm 4 can be remarkably reduced.

Thereby, the speaker unit 3 in which the diaphragm 4 is built can be vibrated in one body almost without generating split vibration in the diaphragm 4; high quality sound by accurately reproducing an input signal can be produced.

Further, in the diaphragm 4, the reinforcement board 17 is interposed between the top layer 4A and the back layer 4B, and the reinforcement board 17 is totally buried inside. Therefore, there is almost no possibility that the reinforcement board 17 comes off or falls off by aging, vibration or the like. Thus, the speaker unit 3 having the above diaphragm 4 can keep producing high quality sound for a long time.

Furthermore, in the diaphragm 4, plural holes are provided on the plate-like part 17A of the reinforcement board 17, and truss structure is formed by the member parts 17A1 and 17A2 other than the plural holes (FIG. 5) or the like. Therefore, the reinforcement board 17 is buried while keeping the rigidity of the plane part 4D. Thus, increasing the weight can be restrained at minimum requirement.

Thereby, in the speaker unit 3, lowering of vibration speed accompanied with an increase of the weight of the diaphragm 4 can be restrained at minimum requirement; sound quality is almost not deteriorated.

Moreover, in the speaker unit 3, the diaphragm 4 is formed in an almost pentagonal cone shape. Therefore, even if split vibration occurred, resonance can be prevented by that the parts of inverted vibration are set to five so that the parts of inverted vibration are not mutually diagonally positioned. Thus, deterioration of sound quality can be limited at minimum.

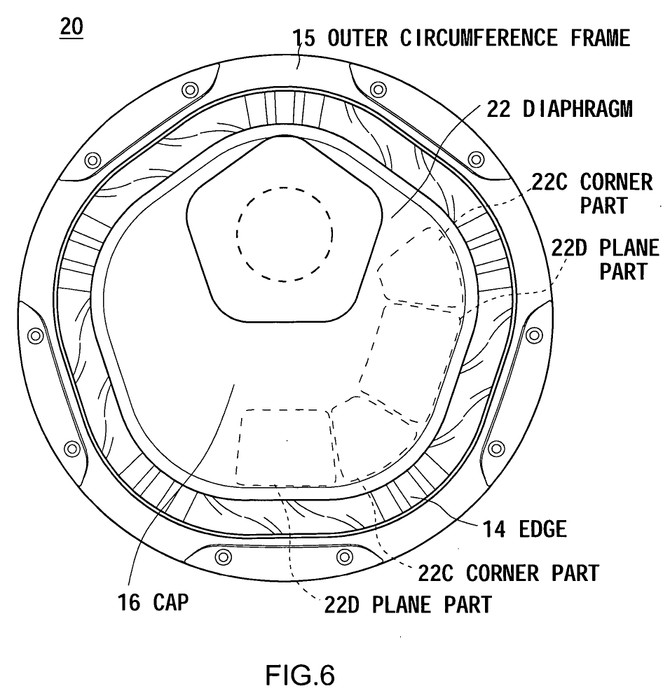

Here, the configuration of a conventional speaker unit 20 is shown in FIG. 6 that corresponds to FIG. 2. The conventional speaker unit 20 has a diaphragm 22 in an almost pentagonal cone shape similarly to the diaphragm 4 in the speaker unit 3 in the present invention. However, the diaphragm 22 is not reinforced by anything.

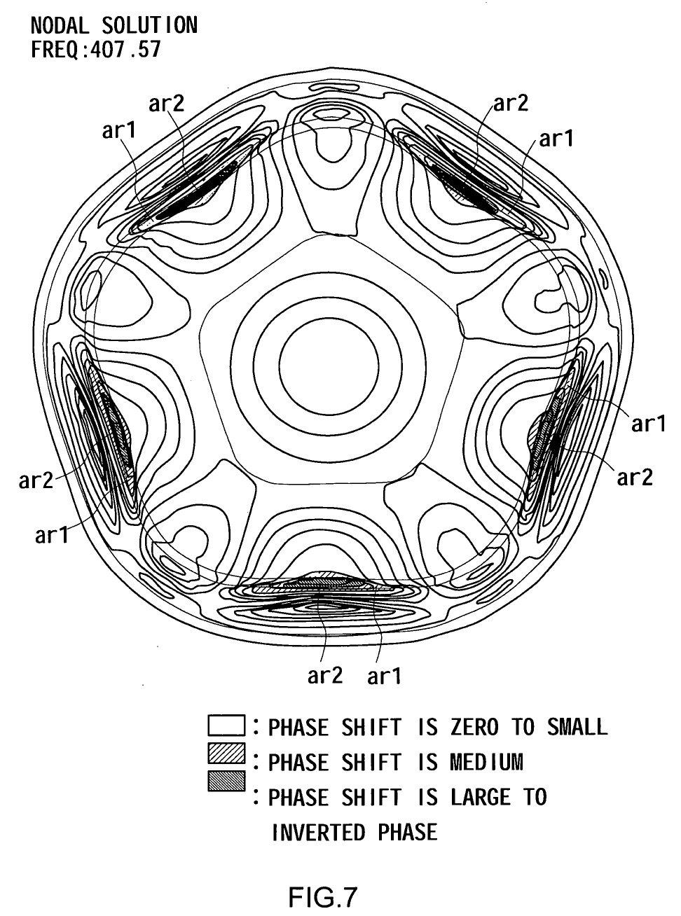

In this conventional speaker unit 20 with the diaphragm 22 built in, the simulation result of vibration that simulated the state where the diaphragm vibrates when in producing a sound is shown in FIG. 7. In this FIG. 7, the distribution of phase shift is shown by dividing an area as a “contour line” in a map, according to the scale of phase shift of vibration in the diaphragm 22.

If comparing FIG. 7 with FIG. 6, in the corner part 22C that corresponds to the center area of the diaphragm 22 and the corner area of the pentagonal cone base, “phase shift is zero to small” in the whole area; the phase shift is small. On the contrary, in the plane part 22D that corresponds to the side of the pentagonal cone base, there are an area arl being “phase shift is medium” and an area ar2 “phase shift is large to inverted phase” in the area of the outer circumference side, and extremely large phase shift is generated.

That is, in the diaphragm 22 of the conventional speaker unit 20, the strength of the corner part 22C corresponding to the “angle” of the pentagonal cone base is comparatively strong, and the strength of the plane part 22D corresponding to the “surface” of the pentagonal cone base is comparatively weak. That is, it can be understood that the relative rigidity of the plane part 22D lacked in comparison with the corner part 22C.

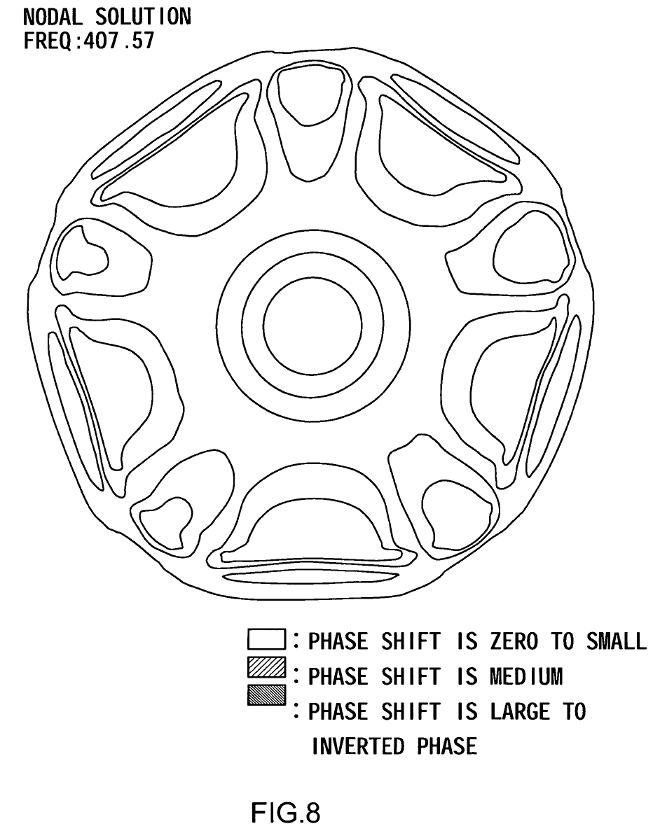

On the contrary, in the speaker unit 3 of the present invention having the diaphragm 4 reinforced by the reinforcement board 17, the simulation result of vibration when in emitting a sound similarly to the case of the conventional speaker unit 20 (FIG. 6) is shown in FIG. 8 that corresponds to FIG. 7.

In the simulation result of vibration in FIG. 8, that phase shift is not almost generated especially in the area of the outer circumference side of the plane part 4D (FIG. 5) in comparison with FIG. 7, and also in the whole diaphragm 4, phase shift is not generated, and the diaphragm 4 is vibrated almost evenly is shown.

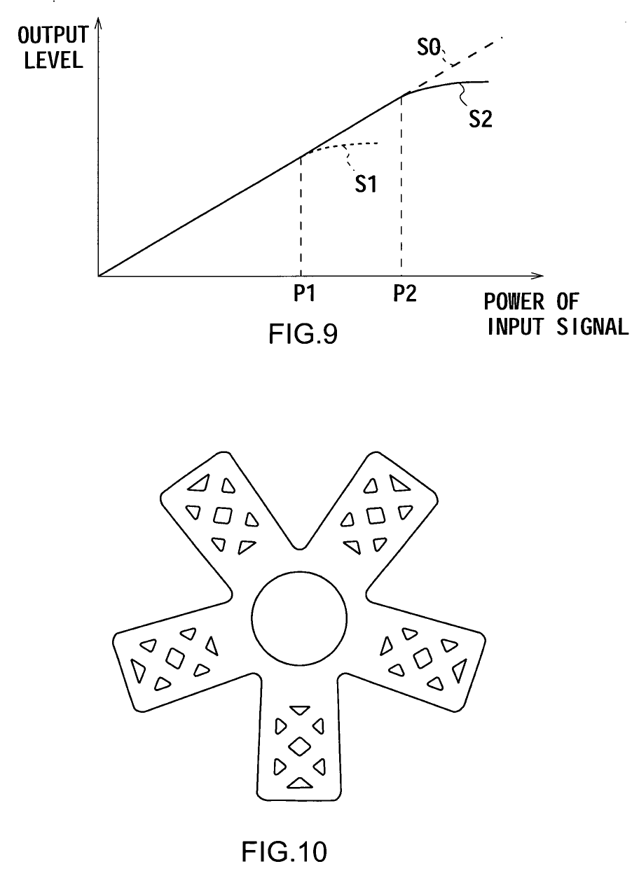

On the other hand, in a speaker unit in general, as shown in FIG. 9, it is ideal that the power of an input signal and output level (that is, the vibration width of a diaphragm) are in proportional relationship and it has linearity as a characteristic curve S0. However, practically, if the power of the input signal becomes a threshold value or over, the diaphragm cannot be vibrated in the vibration width in proportion to the input signal because of lack of the rigidity of the diaphragm. Thus, the linearity of the characteristic curve lowers, and an emitted sound is distorted (that is, the sound quality lowers). The threshold value at this time becomes a different value in every speaker unit, depending on the rigidity of the diaphragm or the like.

For example, in the conventional speaker unit 20 (FIG. 6), the diaphragm 22 is not reinforced. Therefore, when the power of an input signal became a predetermined threshold value P1 or over, the linearity lowers as a characteristic curve S1 in FIG. 9. As a result, an emitted sound is distorted.

On the contrary, in the speaker unit 3 of the present invention, the diaphragm 4 is reinforced by the reinforcement board 17 and rigidity is improved. Therefore, the linearity can be kept to a threshold value P2 that shows power larger than the threshold value P1 as a characteristic curve S2 in FIG. 9. Thus, an emitted sound is not distorted.

We practically listened sounds as a test by means of the speaker apparatus 1 with the built-in speaker unit 3 (FIG. 1), and we confirmed that a high quality sound is kept without occurring split vibration also when the maximum value in the power of an input signal of the speaker unit 3 (that is, 1600 W as the instantaneous maximum input power) was inputted.

According to the above configuration, in the diaphragm 4, the reinforcement board 17 is interposed between the top layer 4A and the back layer 4B by insert molding, and the plane part 4D is reinforced by the plate-like part 17A and rigidity is reinforced to the same degree as the corner part 4C. Therefore, the possibility of occurrence of split vibration is remarkably reduced, and the state where rigidity is high can be kept for a long time. Furthermore, in the speaker apparatus 1, the above diaphragm 4 is built in the speaker unit 3, so that high quality sound by that an input signal is precisely reproduced can be kept emitting.

(3) Other Embodiments

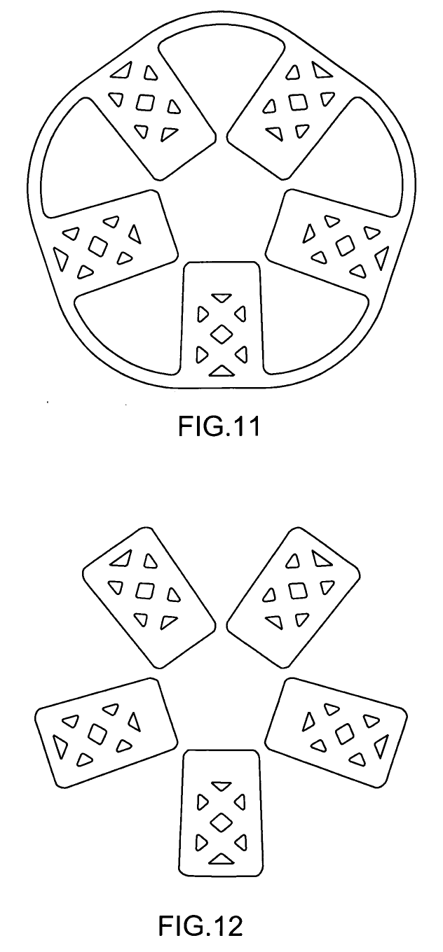

In the aforementioned embodiment, it has dealt with the case where the reinforcement board 17 is composed of the plate-like part 17A, the center part of reinforcement board 17B and the outer circumference part of reinforcement board 17C. However, the present invention is not only limited to this but also for example, the outer circumference part of the reinforcement board may be omitted as shown in FIG. 10, the center part of the reinforcement board may be omitted as shown in FIG. 11, or both of the outer circumference part of the reinforcement board and the center part of the reinforcement board may be omitted as shown in FIG. 12. In short, it is good, provided that the plane part 4D of the diaphragm 4 (FIGS. 4A and 4B) can be reinforced.

Furthermore, in the aforementioned embodiment, it has dealt with the case where plural holes are provided on the plate-like part 17A of the reinforcement board 17, and truss structure is formed by the part other than the plural holes. However, the present invention is not only limited to this but also the plural holes may be arbitrary disposed or no holes may be provided, within the range that both of reducing the weight and keeping the rigidity of the reinforcement board 17 can be satisfied.

Further, in the aforementioned embodiment, it has dealt with the case where the diaphragm 4 is reinforced by the reinforcement board 17 made of aluminum. However, the present invention is not only limited to this but also the diaphragm 4 may be reinforced by a reinforcement board made of other materials such as various metals such as titanium, and carbon fiber.

Further, in the aforementioned embodiment, it has dealt with the case where the diaphragm 4 is formed by insert molding with polypropylene resin. However, the present invention is not only limited to this but also the diaphragm 4 may be formed by insert molding with other various resins.

Further, in the aforementioned embodiment, it has dealt with the case where the reinforcement board 17 is buried in the diaphragm 4 by insert molding. However, the present invention is not only limited to this but also for example, the top layer 4A and the back layer 4B forming the diaphragm 4 may be previously separately molded, and the top layer 4A and the back layer 4B may be put on each other as sandwiching the reinforcement board 17 by vacuum molding. In this case, as to the top layer 4A and the back layer 4B, various materials such as a paper and fiber material may be used, without limiting to resin raw material having plasticity.

Further, in the aforementioned embodiment, it has dealt with the case where the reinforcement board 17 is interposed in the diaphragm 4 of the conic speaker unit 3. However, the present invention is not only limited to this but also the present invention may be applied to a diaphragm for a speaker unit having other form such as a domed shape and a plane shape.

Further, in the aforementioned embodiment, it has dealt with the case where the diaphragm 4 is in an almost pentagonal cone shape. However, the present invention is not only limited to this but also a diaphragm may be formed in other shape such as a cone base shape and an almost heptagonal cone shape.

Further, in the aforementioned embodiment, it has dealt with the case where the present invention is applied to the diaphragm 4 of the speaker unit 3 in the speaker apparatus 1 being a sub woofer for automobile. However, the present invention is not only limited to this but also the present invention may be applied to for example, a diaphragm for a speaker unit for home use, a diaphragm for a speaker unit being a fullrange speaker, a tweeter, or the like.

Further, in the aforementioned embodiment, it has dealt with the case where the diaphragm 4 serving as a speaker diaphragm is formed by the top layer 4A and the back layer 4B serving as a vibrating surface, and the reinforcement board 17 being a thin plate-like member. However, the present invention is not only limited to this but also a speaker diaphragm may be formed by other various vibrating surfaces and thin plate-like members.

The present invention also can be used in various speaker apparatuses such as for automobile and for home use.

What is claimed is:

1. A speaker diaphragm built in a speaker apparatus, comprising:
a vibrating surface forming said speaker diaphragm; and
a thin plate-like member for reinforcement, interposed between a front surface and a back surface of said vibrating surface, and disposed from a center side to a outer circumference side of the speaker diaphragm.

2. The speaker diaphragm according to claim 1, wherein;
said thin plate-like member has truss structure by combined in predetermined truss form.

3. The speaker diaphragm according to claim 1, wherein;
said thin plate-like member has the center part to reinforce a center area of said speaker diaphragm in almost circumference form.

4. The speaker diaphragm according to claim 1, wherein;
said thin plate-like member has the outer circumference part to reinforce the outer circumference side of said speaker diaphragm in circumference form.

5. The speaker diaphragm according to claim 1, wherein;
said thin plate-like member is interposed between said front surface and said back surface of said vibrating surface by insert molding.

6. The speaker diaphragm according to claim 1, wherein:
said speaker diaphragm has a cone shape or a dome shape in almost Nth pyramid form (N is an integer of 3 or over); and
said reinforcement means is disposed from said center side of said speaker diaphragm to the side part other than the angle parts of said almost Nth pyramid.

7. A speaker unit having a speaker diaphragm, wherein;
said speaker diaphragm includes
a vibrating surface forming said speaker diaphragm, and
a thin plate-like member for reinforcement, interposed between the front surface and the back surface of said vibrating surface, and disposed from the center side to the outer circumference side of the speaker diaphragm.

8. A speaker apparatus with a speaker unit having a speaker diaphragm fixed in a predetermined speaker box, wherein;
said speaker diaphragm includes
a vibrating surface forming said speaker diaphragm, and a thin plate-like member for reinforcement, interposed between the front surface and the back surface of said vibrating surface, and disposed from the center side to the outer circumference side of the speaker diaphragm.
